(19) United States
(12) Patent Application Publication
(10) Pub. No.: US 2007/0180365 A1
(43) Pub. Date: Aug. 2, 2007

(54) Automated process and system for converting a flowchart into a speech mark-up language

(76) Inventor: Ashok Mitter Khosla, Palo Alto, CA (US)

Correspondence Address: HAHN AND MOODLEY, LLP, P.O. BOX 52050, MINNEAPOLIS, MN, 55402, US

(21) Appl. No.: 11/342,059

(22) Filed: Jan. 27, 2006

(51) Int. Cl. G06F 17/00; G10L 13/08

(52) U.S. Cl. 715/523; 704/260; 715/513

(57) ABSTRACT

In one embodiment a method for a data processing system is provided. The method comprises reading data corresponding to a flowchart; and generating an equivalent representation of the flowchart in a speech mark-up language. The flowchart may have been created in an arbitrary programming environment, and generating the equivalent representation is independent of a programming environment that was used to create the flowchart.

### FIELD

Embodiments of this invention relate to the generation of content for a speech application such as is used in a voice response system.

### BACKGROUND

Voice response systems such as is described in co-pending U.S. patent application Ser. No. 10/319,144, which is hereby incorporated by reference, describes a conversational voice response (CVR) system. The conversational voice response system includes a voice user-interface which includes voice content such as prompt and other information to be played, and logic or code that is able to receive a user's utterance and determine which portion of the voice content to play in response to the utterance.

In cases where the voice content comprises a large amount of information, structuring the content into a form that can be played by the voice user-interface can be time consuming, and tedious.

### BRIEF DESCRIPTION OF THE DRAWINGS

FIG. 1 shows a sample flowchart that may be converted to an equivalent representation in a speech mark-up language, in accordance with one embodiment of the invention;

FIG. 2 shows the operations to convert a flowchart to its equivalent representation in a speech mark-up language in accordance with one embodiment of the invention; and

FIG. 3 shows hardware for a data processing system in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment of the invention, a technique is described whereby, a visual or graphical representation of a “conversation flow” is taken as input, and converted into a marked up document that can be used by the conversational voice response system described in U.S. patent application Ser. No. 10/319,144. The marked up document defines the semantic and logical meaning of a body of text. In one embodiment, the marked up document is marked up using tags defined in a markup language such as the extensible markup language (XML), or a derivative thereof. Table 1 below shows examples of tags that could be used to markup the document. A more detailed discussion of each tag is included in appendix 1.

TABLE 1

| Category | TAG | Description |
|---|---|---|
| Header | ID | An ID tag is used to identify the text document and is usually |
| | | its filename. |
| | Title | A Title tag is used to identify topic content. The format of a Title |
| | | tag is generally a verb followed by nouns, e.g., “Troubleshooting |
| | | Paper Jams.” |
| | Essence | An Essence tag specifies the gist or essence of a topic. The |
| | | Essence tag may be used to generate prompts for Navigation |
| | | topics and “guide me” topics. For example: AskWould you like |
| | | help with Essence1 or Essence2? |
| | Subject | A Subject tag may be used to identify important nouns and |
| | | noun phrases uttered by the caller to access a particular topic. |
| | Type | A Type tag may be used to identify the topic type, e.g., |
| | | Subject, Navigation, System, Concept Memory, or Field. |
| Guidance | Intro | An Intro tag may be used to identify a prefacing sentence or a |
| | | topic summary. |
| | Task | A Task tag may be used to identify “to do” information for the |
| | | caller. The sentence typically starts with a verb form. |
| | Guidance | A Guidance tag may be used to mark sentences that are not |
| | | directly task-oriented, but may describe why a task must be |
| | | performed. |
| | Wait | A Wait tag may be used to insert an execution time for a Task |
| | | which is needed by the caller. This tag is usually preceded by |
| | | a Guidance tag stating that the system will wait for a given |
| | | amount time. |
| | Comment | A Comment tag may be used to identify content that is not |
| | | part of a topic but may be inserted for an operator/writer's |
| | | future benefit. |
| Question | Confirm | The Confirm tag may be used for if/then constructions. The |
| | | answer to a Confirm tag is yes/no. |
| | Ask | An Ask tag may be used for open-ended questions and |
| | | directed dialogue to present a list of options for the caller to |
| | | choose from. |
| Answer | Agree | An Agree tag may be applied to responses to a Confirm tag |
| | | question. Agree tags are yes/no. |
| | Reply | Reply tag may be used with responses from callers that |
| | | include keywords/subjects, or a selection from a list presented |
| | | in an Ask tag Question. |
| Navigation | Label | The Label tag may be used to mark a point in the file that the |
| | | operator/writer may want to reference, either from the current |
| | | topic, or from another topic. Each Label tag must be given a |
| | | name. |
| | Jump | A Jump tag may be used to define the point in a topic at which |
| | | the conversation branches off to another topic. A Jump tag |
| | | must be followed by a filename, or a filename followed by a # |
| | | sign and a Label. |
| | PlayTopic | A PlayTopic tag may be used to transfer the flow of |
| | | conversation from one topic, i.e., the calling topic, to another |
| | | topic, i.e., the called topic. When the system reaches the |
| | | PlayTopic tag, it marks its point in the calling topic, plays the |
| | | called topic, and then returns to the calling topic. The PlayTopic |
| | | tag must be followed by a topic name, or a topic name |
| | | followed by a # sign and a Label. |
| | Return | A Return tag may be placed in a called topic to mark the point |
| | | where the conversation flows back to the calling topic. This |
| | | may be used when the operator/writer does not want the |
| | | entire called topic to be played. |
| Concept Memory | Set | A Set tag may be used to set the value of a Concept |
| | | (variable). |
| | Clear | The Clear tag may be used to clear the value of a global |
| | | Concept to NotSet. |
| Field | Record | The Record Tag may be used to allow the caller to leave a |
| | | recorded message accessible for CVR reports. |

Data corresponding to the aforementioned “conversation flow,” hereinafter referred to as a “flowchart,” already in existence is substantial. Thus, the techniques of the present invention to convert such flowcharts into a marked up document as described, has great utility as it facilitates the rapid construction of a CVR system without the tedium usually associated with generating content. Other advantageous of the technique described herein, will be apparent from the description below.

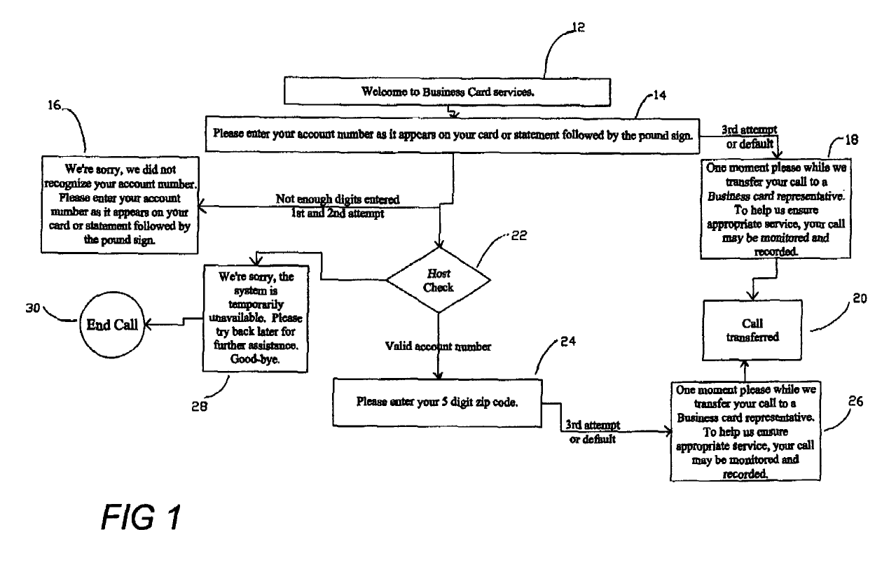

Turning now to FIG. 1 of the drawings, a sample flow for a CVR application relating to a call center designed to handle business credit card inquiries is shown. As will be seen, at block 12 the prompt “welcome to business card services” is uttered, when a call is first received. At block 12, the prompt “please enter your account number as it appears on your card or statement followed by the pound sign” is then played or spoken to the caller. At that point the CVR system waits for input of the account number. If not enough digits are entered on the first or second attempts then control flows to block 16 where the prompt “We're sorry, we did not recognize your account number. Please enter your account number as it appears on your card or statement followed by the pound sign” is played. The CVR system is configured, upon the third attempt to enter the account number or by default, to go to block 18 where the prompt “One moment please while we transfer your call to a business card representative. To help us ensure appropriate service, your call may be monitored and recorded” is played. Upon the completion of block 18, block 20 executes as a result of which the call is transferred to a business card representative. At block 22, a “host check” is performed in order to determine the availability of a host system. If the host check fails then block 28 executes wherein the prompt “We're sorry, the system is temporarily unavailable. Please try back later for further assistance. Goodbye.” Is played. After execution of block 28, block 30 executes, where the call is ended. If at block 22, the “host check” is successful then block 24 executes, wherein the prompt “please enter your five digit zip code” is played. The CVR system may be configured to pass control after block 24 to block 26 upon the third attempt to enter the five digit zip code, or upon default. At block 26, the prompt “One moment please while we transfer your call to a business card representative. To help us to ensure appropriate service, your call may be monitored and recorded” is played. Control from block 26 passes to block 20, where the call is transferred to the business card representative.

Flowcharts similar to the flowchart shown in FIG. 1 of the drawings, may be constructed to capture the content, and call flow for various portions of a CVR application. It will be appreciated, that representing the call flow in the visual form of a flowchart facilitates the process of creating content for the CVR application, as it allows the person generating the content to see the structure of the content, in a way that representing the content purely as text does not allow. As such, the techniques of the present invention that convert a flowchart into a marked up language document to be played by a voice player in a conversational response system has even greater utility.

The flowchart shown in FIG. 1 of the drawings, will be used as a representative example of flowcharts that may in general be converted in accordance with the techniques of the present invention, into a marked up language document that can be played by a conversational voice response system.

The techniques disclosed herein, may be performed by a data processing system, such as shown in FIG. 4 of the drawings and described later. Broadly, the data processing system reads data corresponding to a flowchart, and generates an equivalent representation of the chart in a speech markup language. As used herein, the term “speech markup language” refers to a markup language that includes constructs that can mark various portions of the document in accordance with its semantic and logical meaning within a conversation. An example of the constructs/tags corresponding to one such speech markup language is shown in Table 1. Using the tags corresponding to the markup language shown in Table 1, the flowchart of FIG. 1, may be equivalently represented as the markup language document of Appendix 2, using the techniques of the present invention.

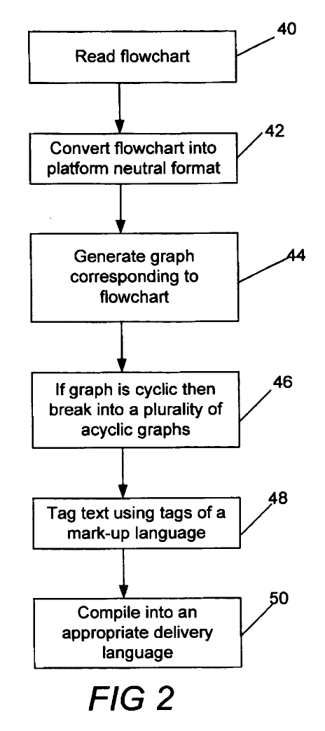

The particular operations that are performed by the data processing system in order to convert a chart into its equivalent representation in a speech markup language, in accordance with one embodiment of the invention, is shown in FIG. 2 of the drawings. Referring to FIG. 2, at block 40 a flowchart to be converted into an equivalent representation in a speech markup language which is read by the data processing system. At block 42, the data processing system converts the flowchart into a platform neutral format. For example, the flowchart may initially be in a Visio .vsd binary format. In this case, the operations at block 42 may convert the Visio .vsd binary format to a .vdx XML text format.

At block 44 the data processing system generates a graph corresponding to the flowchart. To generate the graph at block 44, shape and linking information for the various objects in the flowchart are analyzed. Shape information refers to the type of bounded boxes used in the flowchart. Examples of bounded boxes include rectangles and diamonds. Generally, a diamond shaped box represents a decision/question whereas a rectangular shaped box represents a prompt, or a comment. Linking information refers to the lines that connect the various bounded boxes, as well as to the direction of arrows used in conjunction with the lines. In one embodiment, vertices of the graph are defined by the content/text associated with each bounded box/object.

At block 46, the graph is analyzed to determine if it is cyclic, if the graph is cyclic, then the graph is broken up into a plurality of acyclic graphs.

At block 48, the data processing system tags text strings occurring in the flowchart, usually within the bounded boxes, with tags of a markup language. The operations at block 48 are based upon an analysis of the linguistic and shape information associated with the text strings. Generally, the tags of the markup language correspond to speech language primitives. Examples of the tags used, in one embodiment, are shown in Table 1. As a result of the processing at block 48, a markup language document such as is shown in Appendix 2, is produced. The markup language may be further refined or edited before a compilation operation is performed at block 52 to compile the markup language document into an appropriate delivery language for use with a conversational voice response system. In one embodiment, an appropriate delivery language is the language known as voice XML (VXML). In one embodiment, in addition to linguistic and shape information, linking information between the various objects/shapes in the flowchart may be used to assist in the tagging process. For example, unconnected shapes are converted to comment primitives and spatial information such as the proximity of a text shape to a known shape is used to identify where to put a comment in the markup language.

It is important to appreciate that in accordance with the techniques described herein, the data processing system of the present invention is able to convert a flowchart into its equivalent representation in a speech mark up language independently of the programming environment that was used to create the flowchart. As such it is not necessary for the flowchart to have been created using a particular programming environment or language. Thus, the techniques described herein work even if the flowcharts to be converted were created in an arbitrary programming environment.

Referring to FIG. 5 of the drawings, an example of hardware 50 that may be used to implement a data processing system, in accordance with one embodiment of the invention is shown. The hardware 50 typically includes at least one processor 52 coupled to a memory 54. The processor 52 may represent one or more processors (e.g., microprocessors), and the memory 54 may represent random access memory (RAM) devices comprising a main storage of the hardware 50, as well as any supplemental levels of memory e.g., cache memories, non-volatile or back-up memories (e.g. programmable or flash memories), read-only memories, etc. In addition, the memory 54 may be considered to include memory storage physically located elsewhere in the hardware 50, e.g. any cache memory in the processor 52, as well as any storage capacity used as a virtual memory, e.g., as stored on a mass storage device 60.

The hardware 50 also typically receives a number of inputs and outputs for communicating information externally. For interface with a user or operator, the hardware 50 may include one or more user input devices 56 (e.g., a keyboard, a mouse, etc.) and a display 58 (e.g., a Cathode Ray Tube (CRT) monitor, a Liquid Crystal Display (LCD) panel).

For additional storage, the hardware 50 may also include one or more mass storage devices 60, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 50 may include an interface with one or more networks 62 (e.g., a local area network (LAN), a wide area network (WAN), a wireless network, and/or the Internet among others) to permit the communication of information with other computers coupled to the networks. It should be appreciated that the hardware 50 typically includes suitable analog and/or digital interfaces between the processor 52 and each of the components 54, 56, 58 and 62 as is well known in the art.

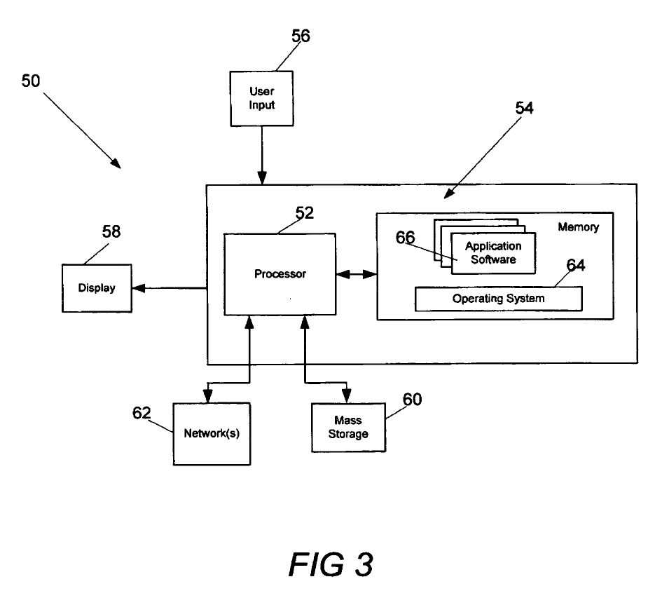

The hardware 50 operates under the control of an operating system 64, and executes various computer software applications, components, programs, objects, modules, etc. (e.g. a program or module which performs operations described above) to perform other operations described with reference to FIGS. 1 through 4. Moreover, various applications, components, programs, objects, etc. may also execute on one or more processors in another computer coupled to the hardware 50 via a network 62, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modifications and changes can be made to these embodiments without departing from the broader spirit of the invention as set forth in the claims. Accordingly, the specification and drawings are to be regarded in an illustrative sense rather than in a restrictive sense.

What is claimed is:

1. A method for a data processing system, comprising:
reading data corresponding to a flowchart; and
generating an equivalent representation of the flowchart in a speech mark-up language.

2. The method of claim 1, wherein the flowchart was created using an arbitrary programming environment.

3. The method of claim 1, wherein generating the equivalent representation is independent of a programming environment that was used to create the flowchart.

4. The method of claim 1, further comprising compiling the equivalent representation into a delivery language.

5. The method of claim 1, wherein reading the data corresponding to the flowchart comprises converting the data into a mark-up language format.

6. The method of claim 5, wherein generating the equivalent representation of the flowchart comprises first generating a network graph to represent the flowchart.

7. The method of claim 6, wherein generating the network graph is based upon shape and linking information about objects in the flowchart.

8. The method of claim 6, further comprising determining if the network graph is cyclic; and transforming said network graph into a plurality of acyclic graphs if it is cyclic.

9. The method of claim 8, further comprising tagging each object in the network graph with a speech language primitive.

10. The method of claim 9, wherein the tagging is based upon a content of text information associated with the object.

11. The method of claim 9, wherein the tagging is based upon shape information associated with the object.

12. The method of claim 9, wherein the tagging is based upon spatial information about a location of the object in the flowchart.

13. A system, comprising:
a processor; and
a memory coupled to the processor, the memory storing instructions which when executed by the processor cause the system to perform a method comprising:
reading data corresponding to a flowchart; and generating an equivalent representation of the flowchart in a speech mark-up language.

14. The system of claim 13, wherein the flowchart was created using an arbitrary programming environment.

15. The system of claim 13, wherein generating the equivalent representation is independent of a programming environment that was used to create the flowchart.

16. The method of claim 1, further comprising compiling the equivalent representation into a delivery language.

17. The method of claim 13, wherein reading the data corresponding to the flowchart comprises converting the data into a mark-up language format.

18. A computer readable medium, having stored thereon a sequence of instructions which when executed by a processing system, cause the system to perform a method comprising:
reading data corresponding to a flowchart; and
generating an equivalent representation of the flowchart in a speech mark-up language.

19. The computer readable medium of claim 18, wherein the flowchart was created using an arbitrary programming environment.

20. The computer readable medium of claim 18, wherein generating the equivalent representation is independent of a programming environment that was used to create the flowchart.
